(19) United States
(12) Patent Application Publication
(10) Pub. No.: US 2007/0133093 A1
(43) Pub. Date: Jun. 14, 2007

(54) Projection lens

(76) Inventors: Hans-Jurgen Dobschal, Kleinromstedt (DE); Robert Brunner, Jena (DE); Reinhard Steiner, Stadtroda (DE); Knut Hage, Apolda (DE); Klaus Rudolf, Jena (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/529,574

(22) PCT Filed: Sep. 19, 2003
(86) PCT No.: PCT/EP03/10476

§ 371 Date: Jan. 16, 2007

(30) Foreign Application Priority Data
Sep. 30, 2002 (EP) 102 45 558.9

(51) Int. Cl. G02B 27/42

(52) U.S. Cl. 359/558; 359/566

(57) ABSTRACT

In imaging optics with main optics having several optical elements, and in which the main optics are corrected for an observation radiation, there is further provided a transmissive, diffractive element, which is arranged and provided in the observation beam path of the imaging optics such that, due to the diffractive effect of the diffractive element, at least one aberration of the main optics is corrected for an inspection radiation having a different wavelength than that of the observation radiation.

The invention relates to imaging optics with main optics comprising a plurality of optical elements, said main optics being corrected for an observation radiation.

Such imaging optics which may be, for example, microscope optics for inspection of masks or wafers, should often be autofocusable. Since, in most cases, autofocusing is employed simultaneously with the use of the imaging optics, it is required to change over to radiation having a wavelength for autofocusing which is outside the wavelength region of the observation radiation.

In microscope optics for inspection of masks or wafers the wavelength of the observation radiation is, in many cases, in the deep-UV region (for example, 157 nm, 193 nm or 248 nm), and the wavelength of the inspection radiation for autofocusing is, in many cases, between 650 and 820 nm. In order to ensure correct functioning of said autofocusing, it is necessary to correct the imaging optics such that, when the imaging optics are ideally focused onto a sample to be inspected, the focus for the observation radiation coincides with the focus for the inspection radiation and that, in the case of defocusing, the imaging optics show at least a similar behavior for the observation radiation and for the inspection radiation.

Due to the great wavelength difference between the observation radiation (deep UV region) and the inspection radiation for autofocusing (650-820 nm), enormously complex optics are required in order to command, for example, the longitudinal chromatic aberration for both the observation radiation and the inspection radiation. In many cases, this is possible only insufficiently or at the cost of the quality of imaging for the observation radiation.

In view thereof, it is an object of the invention to provide imaging optics which are sufficiently corrected, especially with regard to chromatic errors of imaging, e.g. the longitudinal chromatic aberration, for both an observation radiation and an inspection radiation having a different wavelength than the observation radiation, even if the wavelength difference between both radiations is great.

According to the invention, the object is achieved by imaging optics with main optics comprising a plurality of optical elements, said main optics being corrected for an observation radiation, and said imaging optics further comprising a transmissive, diffractive element, which is arranged in the observation beam path of the imaging optics and, in particular, essentially does not change the imaging properties of the main optics for the observation radiation, said diffractive element being further provided such that, due to the diffractive effect of the diffractive element, at least one aberration of the main optics is corrected for an inspection radiation having a different wavelength than that of the observation radiation.

Since the diffractive element essentially does not change the imaging properties of the main optics for the observation radiation, this clearly reduces the complexity of the optical correction of the main optics. In many cases of application of the imaging optics according to the invention (in particular, when used as microscope optics for inspection of masks or wafers), this allows to achieve certain optical solutions which would not be conceivable conventionally (i.e. using only refractive optical elements).

Thus, the diffractive element (also referred to hereinafter as diffraction grating) contributes nothing or not much to the imaging properties of the imaging optics with regard to the observation radiation and is, therefore, optically uncoupled from the imaging optics for the observation radiation. This considerably simplifies the optical design of such imaging optics.

The teaching according to the invention obviates the hitherto existing obligation to select the wavelength of the inspection radiation to be as close as possible to the wavelength of the observation radiation for reasons of correction, thus obviating the need, with respect to the inspection radiation, for laser diodes having short wavelengths (in the UV region), which are relatively expensive. The imaging optics according to the invention can be realized even more easily the more the wavelength of the inspection radiation differs from the wavelength of the observation radiation. Thus, the wavelength for the inspection radiation can be moved further into the infrared region if the wavelength of the observation radiation is, for example, in the UV region (wavelength of less than 300 nm). There is a good and reasonably priced selection of suitable laser diodes in the infrared region, which results in a reduction of the manufacturing cost of the imaging optics according to the invention.

In particular, the diffracted inspection radiation of a predetermined order of diffraction which is not the zeroth order can be employed in the imaging optics according to the invention in order to correct the aberration, which is preferably a chromatic aberration (e.g. the longitudinal chromatic aberration or the color-dependent aperture aberration). In doing so, the diffracted inspection radiation of the positive or negative first order is preferably used, because it is easy to produce gratings for this order of diffraction which have a high diffraction efficiency in this order of diffraction. In this case, diffraction efficiency means the intensity of the exiting radiation of the corresponding order of diffraction relative to the intensity of the incident radiation.

In a preferred further embodiment of the imaging optics according to the invention, the diffraction efficiency of the diffractive element for the zeroth order of diffraction of the observation radiation (the observation radiation of the zeroth order of diffraction is the non-diffracted observation radiation) is greater than the sum of the diffraction efficiencies of all other orders of diffraction of the observation radiation. In particular, the diffraction efficiency for the zeroth order of diffraction is several times greater than the sum of the diffraction efficiencies of the other orders of diffraction. This ensures that the diffractive element essentially does not change the imaging properties of the main optics with regard to the observation rays.

Further, the diffraction efficiency of the diffractive element for the zeroth order of diffraction of the observation radiation may be at least 80%. This magnitude of the diffraction efficiency ensures that the imaging properties of the main optics for the observation radiation are essentially not changed by the diffraction grating.

In particular, the diffractive element of the imaging optics may be a phase grating. As compared to an amplitude grating, this has the advantage of not just blocking out parts of the incident radiation, so that nearly the entire intensity of the radiation incident on the diffractive element can be used.

Further, the diffractive element in the imaging optics according to the invention may be a grating having symmetry, preferably rotation-symmetry, about the optical axis of the main optics. A symmetric grating is easy to manufacture and, due to its symmetry, can also be aligned more easily within the imaging optics during manufacture thereof.

A particularly preferred further embodiment of the imaging optics according to the invention consists in that the grating frequency of the diffractive element increases radially outwardly from the optical axis of the main optics. This allows the desired correction of aberration to be realized for the inspection radiation.

In order to achieve, if possible, the optimum in diffraction efficiency for the inspection radiation, the depressions of the diffractive element are formed such, in a preferred further embodiment of the invention, that the depth of the individual depressions decreases as the radial distance from the depression to the center of the diffractive element increases.

However, as an alternative, the depressions may also be formed such that they all have the same depth. In this case, the manufacture of the grating is simplified.

In particular, the diffractive element may comprise annular depressions, which are concentrically provided. Such diffractive element may be formed, for example, by means of the holographic standing-wave method.

The diffractive element may be formed, for example, on one side of a plane-parallel plate. This provides the advantage that the production on a planar side is easily possible with the desired precision.

Since the diffractive element essentially does not change the imaging properties of the main optics with regard to the observation radiation, a change in the wavelength of the inspection radiation only requires the existing diffractive element to be replaced with a diffractive element that is adapted to the new wavelength. Changes to the main optics are not required, thus allowing easy and fast adaptation to the other wavelength of the inspection radiation. In particular, when the diffractive element is formed on a plane-parallel plate, such replacement is easy to realize.

Alternatively, the diffractive element may also be provided on an optically effective surface of a refractive optical element in the main optics. This is advantageous insofar as no additional body (e.g. the plane-parallel plate) needs to be provided in the main optics, thus allowing to minimize the size and also the weight of the imaging optics. Due to the smaller number of elements of the imaging optics, the manufacture of the imaging optics can also be effected in a faster and less costly manner.

A preferred embodiment of the imaging optics according to the invention consists in that the diffractive element is provided only in an annular region on the side of the plane-parallel plate or on the optically active surface of the optical element, respectively. This is advantageous, for example, for certain autofocusing principles wherein the inspection radiation, for autofocusing, only passes through an annular region in a plane perpendicular to the optical axis of the imaging optics. The observation radiation, however, will usually pass into the entire region, i.e. also the region enclosed by the annular region, so that the influence of the diffractive element (due to its smaller surface area) on the observation radiation can already be minimized or almost completely suppressed, respectively, for this reason alone.

Further, the diffractive element may be provided as a blaze grating (grating having a sawtooth profile). In a blaze grating, the diffraction efficiency is extremely high for the desired order of diffraction, so that low-intensity light sources can be used for the inspection wavelength.

If the blaze grating is formed by means of holographic methods (e.g. the holographic standing-wave method), the flanks of the depressions will be continuous, so that, advantageously, practically no diffuse scattered radiation is generated by the illumination radiation.

Alternatively, the diffractive element may also have a blaze structure approximated in steps. In this case, each effective flank is approximated by a step function, with two steps per flank being provided in the simplest case. Such diffractive element may be manufactured, for example, by means of patterning processes known from the manufacture of semi-conductors, wherein any desired profile pattern may be realized. Thus, it is possible, in particular, to generate profile patterns which cannot be generated by holographic methods at all, or only with great difficulty.

The diffractive element may preferably be arranged in the region where the observation radiation has largest beam diameter in the main optics. This leads to the advantage that diffracted radiation of the non-zeroth order of the observation radiation, if it is generated, is largely cut off by the mounts of the optical elements arranged following the diffractive element, or it exits the objective with an intercept distance clearly differing from that of the observation radiation (zeroth order of diffraction) diffracted by the diffractive element and used for imaging, so that the diffracted radiation which is not of the zeroth order is very strongly expanded and, thus, leads to a very slight deterioration in imaging at the most.

In a further embodiment of the imaging optics according to the invention, the main optics comprise a second diffractive element which has a diffraction-enhancing and achromatizing effect for the observation radiation. Since the dispersion of a diffractive element is counter-current to the dispersion of refractive elements, the imaging optics according to the invention require the use of few, if any, fluorite lenses for achromatization for applications in the UV region (as compared to imaging optics without a diffractive element). This leads to a considerable simplification of the manufacture of the imaging optics as compared to conventional imaging optics for the UV region which usually also contain fluorite lenses due to the required achromatization.

The second diffractive element also advantageously allows reduction or correction of further aberrations, such as the spherical aberration and coma of the main optics, so that these aberrations advantageously no longer occur.

Further, the second diffractive element has a relatively strong positive refractive power (or strong positive effect, respectively) as compared to a refractive element, so that the number of optical elements of the imaging optics according to the invention is clearly reduced as compared to imaging optics constituted of exclusively refractive elements. This is particularly advantageous, especially in high performance imaging optics which are achromatized for a wavelength range of a few nanometers or less, because, due to the extremely high precision required in manufacturing and adjusting the optical elements, any optical element saved leads to imaging optics which are clearly more economical and faster to produce.

Moreover, a much shorter face-to-face dimension of the imaging optics according to the invention as compared to conventional (purely refractive) imaging optics is advantageously realizable with the same aperture and the same working distance, allowing the imaging optics according to the invention to be easily realized as an exchangeable objective, which may be inserted into already existing devices, such as optical inspection systems and microscopes, without having to change these devices for this purpose. This allows said devices to be easily re-fitted, without any problem, with the imaging optics according to the invention, which may have a very high numerical aperture and, at the same time, a very great working distance.

The second diffractive element may preferably be designed such that, in addition to its achromatizing and refraction-enhancing effect, spherical aberrations of a higher order caused in the main optics by the remaining optical elements are also compensated for.

Further, the second diffractive element, which is responsible for the achromatizing effect of the observation radiation in the imaging optics according to the invention, allows to prevent the problems of the excessively small edge thicknesses and excessively small air gaps between the lenses, which occur in imaging optics consisting exclusively of refractive elements, in particular at the lens edges, due to the required achromatization, which extremely complicates the mounting technology, so that, advantageously, the mounting of the optical elements is clearly simplified in the imaging optics according to the invention. This is another reason why manufacture of the imaging optics according to the invention is economical and fast.

In particular, the second diffractive element does not substantially influence the imaging properties of the main optics for the inspection radiation. This leads to the advantage that correction of the aberration in the main optics for the inspection radiation is carried out exclusively by the first diffractive element.

If the diffraction efficiency of the second diffractive element is greater, for the zeroth order of diffraction of the inspection radiation, than the sum of the diffraction efficiencies of all other orders of diffraction of the inspection radiation, then the diffraction-dependent effect of the second diffractive element on the inspection radiation can be neglected.

In particular, using the second diffractive element, the desired achromatization of the main optics can be fully achieved in the imaging optics according to the invention for a wavelength region containing the wavelength of the observation radiation. If the desired achromatization is the complete achromatization of the imaging optics with respect to the observation radiation, optical systems arranged following the imaging optics, such as a tube lens in a microscope, may be designed completely independently of the imaging optics in terms of their achromatizing properties. Alternatively, the desired achromatization may be an incomplete achromatization of the imaging optics according to the invention, so that the beam exiting the sample to be inspected on the side facing away from the imaging optics is not completely achromatized. The missing contribution to complete achromatization may then be provided, if desired, by an optical system (e.g. a tube lens in a microscope) arranged following the imaging optics.

In the imaging optics according to the invention, the achromatization of the main optics (which is preferably not achromatized itself at all) may be effected essentially or even exclusively by the at least one second diffractive element (or also by several second diffractive elements).

In a preferred further embodiment of the imaging optics according to the invention, all optical elements of the main optics and the first diffractive element are formed of a maximum of two different materials, preferably of the same material. Since achromatization is caused by the second diffractive element, materials may be selected which are best suited for the spectral range of the observation radiation. For example, the material having the best transmission properties and/or the material which is the easiest to work may be selected. Thus, the optical elements may consist, for example, of quartz and/or calcium fluoride.

In the case of an observation radiation of 193 nm, 248 nm and 266 nm, suprasil, a synthetic quartz, is preferred, and at 157 nm fluorite is the preferred material.

In particular, in the imaging optics according to the invention, all optical elements of the main optics and the first diffractive element can be mounted without cement. This advantageously avoids the disadvantage of aging and destruction of the cement, which occurs in systems using optical cement, as is the case, in particular, at wavelengths in the UV range, where this represents a great problem. Thus, a very long useful life of the imaging optics according to the invention can be ensured.

In the imaging optics according to the invention, the second diffractive element may preferably be formed on a plane-parallel plate or on an optically active surface of a refractive optical element of the main optics. In particular, the first diffractive element may be provided on one side of a plane-parallel plate or of a refractive optical element of the main optics, and the second diffractive element may be provided on the other side of the plane-parallel plate or of the refractive optical element, respectively. This leads to the advantage that the number of additional elements of the imaging optics may be very small (only one plane-parallel plate) or even zero (one refractive optical element).

In a further embodiment of the imaging optics according to the invention, they are provided as autofocusable imaging optics, which additionally comprise a beam splitter using which the inspection radiation (for autofocusing) can be coupled in and out of the observation beam path of the imaging optics. For example, this beam splitter may be provided such that it reflects the inspection radiation and transmits the observation radiation. Alternatively it may, of course, also reflect the observation radiation and transmit the inspection radiation.

In particular, an autofocusing unit may be additionally provided, which generates the inspection radiation to be coupled in and evaluates the coupled-out inspection radiation with respect to autofocusing. In doing so, autofocusing principles known to the person skilled in the art may be employed. Thus, autofocusing may be effected according to the triangulation principle. For this purpose, the autofocusing unit will be suitably designed.

The wavelength of the inspection radiation is preferably greater than that of the observation radiation, with the imaging optics according to the invention being simpler in design the greater the wavelength distance is. A wavelength distance of at least 100 nm, in particular of at least 400 nm, is preferred.

In particular, the imaging optics (main optics with first diffractive element) are preferably provided such that, when the imaging optics are ideally focused onto a sample to be inspected, the focus of the observation radiation coincides with the focus of the inspection radiation and that, in the case of defocusing, the imaging optics show at least a similar behavior for the observation radiation and the inspection radiation.

Further, there is also provided a method for the manufacture of imaging optics, wherein a main optics comprising a plurality of optical elements is computationally assembled and corrected for a predetermined observation radiation; then a transmissive diffractive element is computationally arranged in the observation beam path of the imaging optics and optimized with regard to its phase function such that the imaging properties of the main optics are essentially not changed for the observation radiation and at least one aberration of the main optics is corrected, by the diffractive effect of the diffractive element, for an inspection radiation having a different wavelength than that of the observation radiation and wherein, further, optical data required for manufacturing the imaging optics thus computed are generated, and the imaging optics are manufactured on the basis of the generated optical data.

The phase function indicates which phase change is imposed on the incident radiation as it passes through the diffractive element. In particular, a polynomial is used as the phase function.

The at least one aberration of the main optics for the inspection radiation may be a chromatic aberration, such as the longitudinal chromatic aberration, for example. In addition, the color-dependent aperture aberration (or color-dependent Gauss aberration, respectively) may also be minimized.

This manufacturing method allows the main optics to be optimized in a known manner without having to bear the imaging properties of the main optics for the inspection radiation in mind. This simplifies the optical design of the imaging optics considerably, in particular if the wavelength distance between the observation radiation and the inspection radiation is great (e.g. greater than 400 nm). The diffractive element is then optimized for correction of the aberration of the main optics for the inspection radiation only after optimizing the main optics for the observation radiation. In order to minimize the effect of the diffractive element on the observation radiation, said element is designed to have an extremely high diffraction efficiency for the zeroth order of diffraction of the observation radiation. This is achieved by the profile shape, there being a tendency for the diffraction efficiency of the zeroth order to increase and the diffraction efficiency of the first order to decrease as the wavelength decreases, if the groove depth is constant. This may be utilized to select a groove depth at which there is a high diffraction efficiency of the zeroth order of diffraction of the observation radiation and a high diffraction efficiency of the first order of diffraction of the inspection radiation, if the wavelength of the inspection radiation (which is preferably used for autofocusing) is greater than that of the observation radiation.

In advantageous further embodiments, the diffractive element may be optimized so as to allow the above-described types of imaging optics to be realized.

The computational assembly of the imaging optics as well as the optimization of the diffractive element are preferably effected by means of a computer. Optimization of the diffractive element may be effected, in particular, by computing the phase changes imposed on the illumination radiation and inspection radiation by the diffraction grating, from which changes the grating effects are then derived. During optimization, the phase changes are set such that the desired grating effects are achieved.

The method according to the invention may also be used, in particular, in hybrid main optics (main optics comprising both refractive and diffractive optical elements). Especially in the case of this type of main optics, it was hitherto almost impossible to achieve simultaneous correction of the longitudinal chromatic aberration for the observation radiation and for the inspection radiation.

In the method according to the invention, when correcting the main optics, the further diffractive element is advantageously designed such that it has a high diffraction efficiency in a predetermined, non-zeroth order of diffraction for the observation radiation (the first order of diffraction being preferred). For the inspection radiation, a high diffraction efficiency may be present for the zeroth order. In optimizing the first diffractive element, however, it is ensured that a high diffraction efficiency is present for the observation radiation in the zeroth order of diffraction. Preferably, a high diffraction efficiency is also given for the inspection radiation in the predetermined, non-zeroth order of diffraction.

The invention will be explained in more detail below, by way of example, with reference to the drawings, wherein:

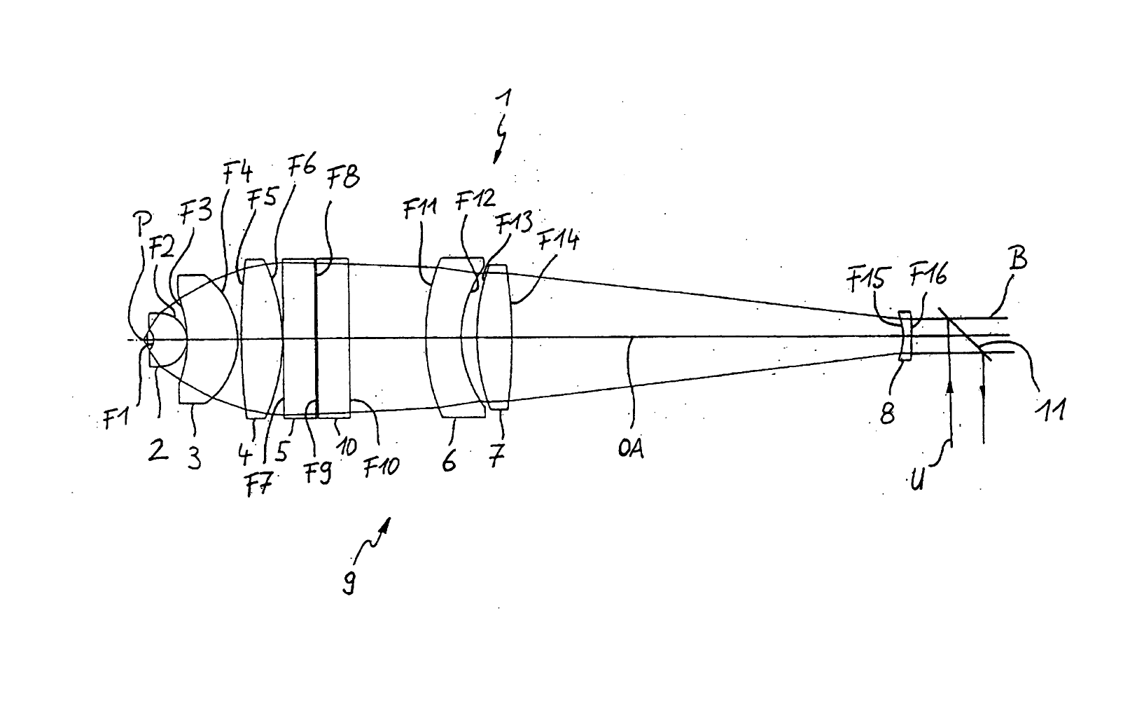

FIG. 1 shows a lens section of the optical structure of the imaging optics according to the invention;

FIG. 2 shows a diagram indicating the grating frequency of the diffractive element;

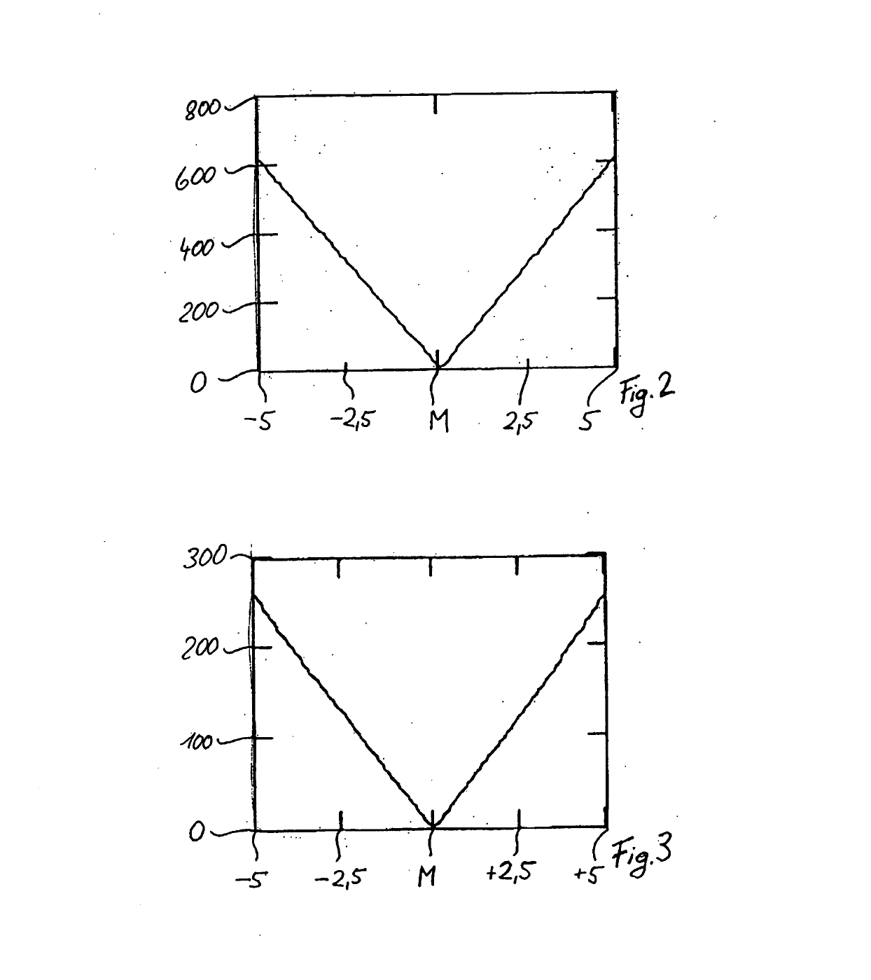

FIG. 3 shows a diagram indicating the grating frequency of the diffraction grating;

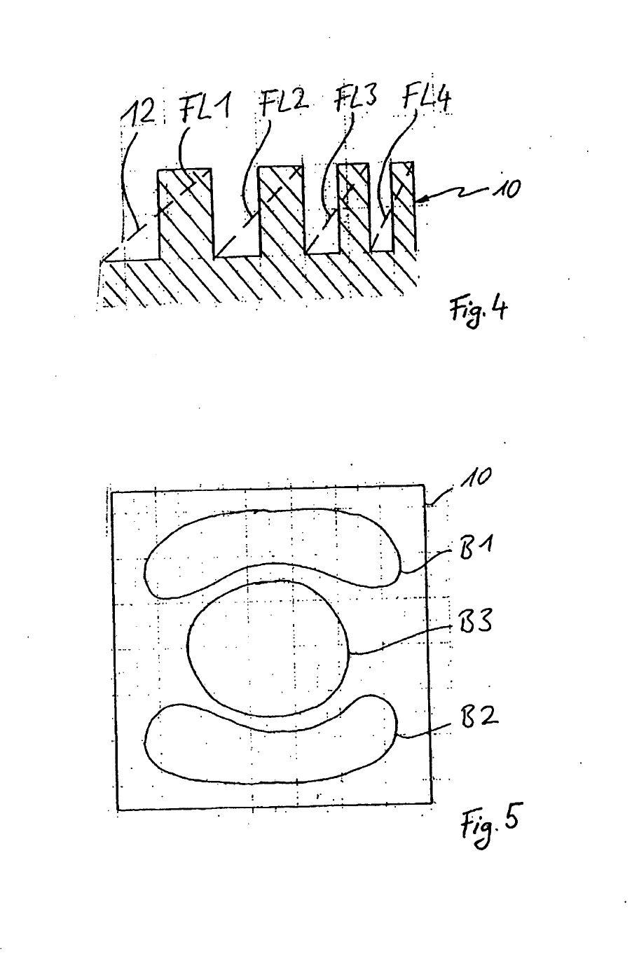

FIG. 4 shows the profile shape of the diffraction grating, and

FIG. 5 shows a top view of the diffraction grating.

As is evident from the lens section, shown in FIG. 1, of the optical structure of the autofocusable imaging optics according to one embodiment the imaging optics 1 comprise a transmissive diffractive element 10 (also referred to hereinafter as diffraction grating) as well as main optics 9, which comprise a plurality of refractive optical elements 2, 3, 4, 6, 7 and 8, as well as a second diffractive element 5. The use of the imaging optics 1 allows imaging of an object of which an object point P in the object plane is indicated. For clarification, three rays of the optical ray path for the observation radiation are shown. Behind the optical element 8, there is a parallel optical ray path.

Further, arranged following the main optics 9 is a beam splitter 11 via which the inspection radiation for autofocusing can be coupled in and out of the beam path for the observation radiation.

The imaging optics 1 are designed for an observation radiation having a wavelength of 248 nm and an inspection radiation having a wavelength of 785 nm, with the main optics 9 being corrected only for the observation radiation (and not for the inspection radiation). The longitudinal chromatic aberration of the main optics 9 for the inspection radiation is corrected by means of the diffraction grating (or the first diffractive element, respectively) 10. In other words, the diffraction grating 10 is designed such that the diffracting effect of the grating 10 with regard to the positive first order of diffraction of the inspection radiation compensates for the longitudinal chromatic aberration of the main optics 9 for the inspection radiation. Thus, the imaging optics (i.e. main optics 9+diffraction grating 10) are corrected, with regard to the longitudinal chromatic aberration, for the inspection radiation used for autofocusing. Further, the diffraction grating 10 is also designed such that its diffraction efficiency for the zeroth order of diffraction of the observation radiation is as high as possible (preferably at least 80%) so that the diffraction grating does not essentially influence the imaging properties of the imaging optics for the observation radiation.

The design and arrangement of the optical elements 2 to 8 (except for the grating profiles) of the imaging optics 9 can be taken from the Table below, wherein the distance of the individual surfaces along the optical axis OA of the imaging optics is indicated (P is the sample plane).

| Surface to | | | | | |
|---|---|---|---|---|---|
| surface | Distance (mm) | Medium | Surface | Radius (mm) | |
| P-F1 | 0.64 | | F1 | 0.89 | (concave) |
| F1-F2 | 2.05 | Suprasil | F2 | 1.68 | (convex) |
| F2-F3 | 0.02 | | F3 | 7.39 | (concave) |
| F3-F4 | 3.09 | Suprasil | F4 | 5.01 | (convex) |
| F4-F5 | 0.20 | | F5 | 40.67 | (convex) |
| F5-F6 | 2.56 | CaF2 | F6 | 11.54 | (convex) |
| F6-F7 | 0.05 | | F7 | planar | |
| F7-F8 | 2 | Suprasil | F8 | planar | |
| F8-F9 | 0.1 | | F9 | planar | |
| F9-F10 | 2 | Suprasil | F10 | planar | |
| F10-F11 | 4.74 | | F11 | 13.14 | (convex) |
| F11-F12 | 2.19 | Suprasil | F12 | 7.39 | (concave) |
| F12-F13 | 0.97 | | F13 | 13.14 | (convex) |
| F13-F14 | 2.16 | CaF2 | F14 | 32.31 | (convex) |
| F14-F15 | 24.65 | | F15 | 3.92 | (concave) |
| F15-F16 | 0.52 | Suprasil | F16 | 18.17 | (convex) |

The second diffractive optical element 5 is a transmissive phase grating in which annular grooves, which are disposed concentrically relative to the optical axis OA of the imaging optics 1, are formed in the surface F6 facing the object plane.

In this case, the second diffractive optical element 5 is designed such that, on the one hand, it has a refraction-enhancing effect for the main optics 9 (i.e. an increase in the positive effect or in the positive refractive power) and that, on the other hand, it causes complete achromatization in the given spectral range for the observation radiation, in which case the diffracted radiation of the positive first order is used as the useful light for imaging. The diffracted radiation of other orders is scattered light, which, if possible, should not contribute to the image so as not to deteriorate it.

The positive first order refers to the first order of diffraction in which a parallel beam (a beam parallel to the optical axis OA) is deflected toward the optical axis OA. On the other hand, the first order of diffraction in which a parallel beam is deflected away from the optical axis OA is referred to as the negative first order of diffraction.

The angle of deflection for the diffracted light of the positive first order is adjusted via the grating frequency of the diffractive optical element 5. In practice, the grating frequency can be calculated by means of optimization calculations on the basis of the following phase polynomial p(r)

$$p ( r ) = {\sum }_{i = 1}^{N} {a}_{i} {r}^{2 i}$$

wherein r is the radial distance from the center M of the phase grating and N is a positive integer greater than 1. For optimization, the coefficients aᵢ are changed. The phase polynomial p(r) indicates the phase shift as a function of the radial distance r, and the grating frequency of the diffractive element can be calculated on the basis of the derivation of the phase polynomial according to the radial distance r. In turn, said grating frequency then allows to determine the angle of emergence of each incident beam (as a function of its wavelength), so that the achromatized and refraction-enhancing effect of the grating may then be determined. In this optimizing calculation, other aberrations of the main optics 5 (such as higher spherical aberrations) can then be corrected as well, wherein a value of 3 to 10 is preferably selected for N. Further, the groove shape which is decisive for the diffraction efficiency can be derived by means of the scalar diffraction theory or also the RCWA theory (Rigorous Coupled Wavefront Analysis), as is known to the person skilled in the art.

The second diffractive element 5 may be generated, for example, by means of the holographic standing-wave method, wherein at least one of the two illumination waves is a spherical wave (and the other is either a spherical wave or a planar wave) and both waves extend in opposite directions. The wavelength of the illumination waves is 248 nm and the distance from the source points of both spherical waves to a layer to be illuminated, which layer is applied onto a plane-parallel plate of suprasil, for example, and in which the latent grating structure is produced, is 35.31 mm each. The illuminated layer is then developed and serves e.g. as a mask in a micro-patterning method (reactive ion etching, for example), which allows the grating profile to be transferred into the plane-parallel plate. FIG. 2 shows the course of the grating frequency of the diffractive element 5. The distance from the grating center M is plotted on the abscissa and the number of grooves per mm is shown on the ordinate. The grating center M coincides with the optical axis OA of the imaging optics 1.

For autofocusing, a diffraction grating for the inspection wavelength is provided on the surface F10, said diffraction grating being a transmissive phase grating. The diffraction grating on the surface F10 is derived from the above-indicated phase polynomial p(r) in the same manner as the diffraction grating of the diffractive element, with the following coefficients aᵢ resulting if a value of 3 is selected for N (the groove shape is again derived by means of the scalar diffraction theory or the RCWA theory):

a_{1:} 1,136*10⁻²

a_{2:} 7,596*10⁻⁶

a_{3:} 6,429*10⁻⁸

The course of the grating frequency of the diffraction grating 10 is shown in FIG. 3 in a similar representation as for the diffractive element 5 in FIG. 2. This shows that the grating frequency of the diffractive element 5 increases more strongly than in the diffraction grating 10.

FIG. 4 also schematically shows the groove shape of the diffraction grating 10, for example, in the order of +2 mm away from the center M. The broken lines show the blaze profile shape 12 which is the result of the above optimization calculation and its derivation (e.g. by means of the RCWA theory). This blaze profile shape 12 is approximated here, for each profile flank FL1, FL2, FL3, FL4, by a step function comprising two steps. It has been shown that such a rectangular profile by which the blaze profile shape 12 is approximated has the desired optical properties.

In practice, the imaging optics 1 for the observation radiation are optimized first. In doing so, only a plane-parallel plate is taken into consideration in optimization for the diffraction grating 10. For this optimization, the second diffractive element 5 is also computed in the above-indicated manner.

After this optimizing step, the desired grating profile is then computationally provided on the surface F10 of the plane-parallel plate 10 and optimized such that the longitudinal chromatic aberration of the main optics 9 is corrected as completely as possible for the inspection radiation and that the diffraction efficiency of the zeroth order of diffraction of the observation radiation is as great as possible, so that the diffraction grating 10 does not substantially deteriorate the imaging properties of the imaging optics already optimized for the observation radiation.

In the imaging optics 1 optimized in this manner, when the imaging optics 1 are ideally focused onto a sample to be inspected, the focus of the observation radiation B coincides with the focus of the inspection radiation U and, in the case of defocusing of the imaging optics, there is at least a similar behavior for the observation radiation B and the inspection radiation U. In the autofocusable imaging optics shown in FIG. 1, a pupil division for the inspection radiation U takes place as indicated by the arrows shown for the inspection radiation U, so that the inspection radiation U impinges on the diffraction grating 10 only in certain regions B1 and B2, as indicated in the schematic top view of the diffraction grating 10 in FIG. 5. The central region B3 limited by the two regions B1 and B2 is not irradiated with inspection radiation U, so that no grating profile of the diffraction grating 10 has to be provided in this region anyway. However, since observation radiation does, in fact, pass through this region B3, this leads to the further advantage that the influence of the diffraction grating 10 on the imaging properties of the main optics for the observation radiation can be further minimized. The regions B1 and B2 are provided in an annular arrangement and may also be provided as a closed annular region.

1-24. (canceled)

25. Imaging optics with main optics comprising:
a plurality of optical elements, said main optics being corrected for an observation radiation, and said imaging optics further comprising a transmissive, diffractive element arranged in the observation beam path of the imaging optics and wherein, due to the diffractive effect of the diffractive element, at least one aberration of the main optics is corrected for an inspection radiation having a different wavelength than that of the observation radiation.

26. The imaging optics as claimed in claim 25, wherein the diffractive element does not substantially change the imaging properties of the main optics for the observation radiation.

27. The imaging optics as claimed in claim 25, wherein the diffracted inspection radiation of a predetermined, non-zeroth order of diffraction is used for correction of said aberration.

28. The imaging optics as claimed in claim 25, wherein the diffraction efficiency of the diffractive element for the zeroth order of diffraction of the observation radiation is greater than the sum of the diffraction efficiencies of all other orders of diffraction of the observation radiation.

29. The imaging optics as claimed in claim 25, wherein the diffraction efficiency of the diffractive element for the zeroth order of diffraction of the observation radiation is at least 80%.

30. The imaging optics as claimed in claim 25, wherein the diffractive element is a phase grating.

31. The imaging optics as claimed in claim 25, wherein the diffractive element is a grating having symmetry.

32. The imaging optics as claimed in claim 31, in which the symmetry comprises rotational symmetry about the optical axis of the main optics.

33. The imaging optics as claimed in claim 25, wherein the diffractive element comprises annular depressions which are concentric.

34. The imaging optics as claimed in claim 33, wherein all the depressions have substantially the same depth.

35. The imaging optics as claimed in claim 33, wherein the depth of the depressions decreases as the radial distance from the optical axis of the main optics increases.

36. The imaging optics as claimed in claim 25, wherein the diffractive element is positioned on one side of a plane-parallel plate.

37. The imaging optics as claimed in claim 25, wherein the diffractive element is positioned on an optically effective surface of a refractive optical element of the main optics.

38. The imaging optics as claimed in claim 36, wherein the diffractive element is positioned only in an annular region on the side of the plane-parallel plate.

39. The imaging optics as claimed in claim 37, wherein the diffractive element is positioned only in an annular region on the optically effective surface of the optical element.

40. The imaging optics as claimed in claim 25, wherein the diffractive element is a blaze grating.

41. The imaging optics as claimed in claim 25, wherein the diffractive element has a blaze profile approximated in steps.

42. The imaging optics as claimed in claim 25, wherein the diffractive element is arranged in the region where the observation radiation has the greatest beam diameter in the main optics.

43. The imaging optics as claimed in claim 25, wherein the main optics comprise a second diffractive element which has a diffraction-enhancing and achromatizing effect for the observation radiation.

44. The imaging optics as claimed in claim 43, wherein the diffraction efficiency of the second diffractive element for the zeroth order of diffraction of the observation radiation is greater than the sum of the diffraction efficiencies of all other orders of diffraction of the observation radiation.

45. The imaging optics as claimed in claim 43, wherein the desired achromatization of the main optics for a wavelength region containing the wavelength of the observation radiation is caused substantially completely by the second diffractive element.

46. The imaging optics as claimed in claim 43, wherein the second diffractive element comprises a transmission grating formed on one side of a plane-parallel plate.

47. The imaging optics as claimed in claim 46, wherein the first diffractive element is positioned on one side of said plane-parallel plate, and the second diffractive element is positioned on the other side of the plane-parallel plate.

48. The imaging optics as claimed in claim 43, wherein the second diffractive element comprises a transmission grating formed on an optically effective surface of a refractive optical element of the main optics.

49. The imaging optics as claimed in claim 48, wherein the first diffractive element is provided on one side of said refractive optical element and the second diffractive element is provided on the other side of the refractive optical element.

50. The imaging optics as claimed in claim 25, wherein all optical elements of the main optics and the first diffractive element are formed of a maximum of two different materials.

51. The imaging optics as claimed in claim 25, wherein all optical elements of the main optics and the first diffractive element are formed of the same material.

52. The imaging optics as claimed in claim 25, wherein all optical elements of the main optics and the first diffractive element are mounted without cement.

53. A method for the manufacture of imaging optics, comprising
computationally assembling a main optics comprising a plurality of optical elements corrected for a predetermined observation radiation;
computationally arranging a transmissive diffractive element in an observation beam path of the imaging optics and optimizing the transmissive diffractive element with regard to its phase function such that at least one aberration of the main optics is corrected by the diffractive effect of the diffractive element for an inspection radiation having a different wavelength than that of the observation radiation;
generating the optical data required for manufacturing the imaging optics thus computed; and
manufacturing the imaging optics on the basis of the generated optical data.
